(19) United States
(12) Patent Application Publication
(10) Pub. No.: US 2026/0285304 A1
(43) Pub. Date: Sep. 24, 2026

(54) DRIVING ASSISTANCE DEVICE, DRIVING ASSISTANCE METHOD, AND STORAGE MEDIUM

(71) Applicant: HONDA MOTOR CO., LTD., Minato-ku, Tokyo (JP)

(72) Inventor: Kotaro Fujimura, Wako-shi (JP)

(21) Appl. No.: 19/168,843

(22) PCT Filed: Mar. 30, 2023
(86) PCT No.: PCT/JP2023/013203

§ 371 Date: Sep. 25, 2025

(51) Int. Cl. B60W 30/095; B60W 50/14

(52) U.S. Cl. CPC B60W 30/095; B60W 50/14; B60W 2554/4041; B60W 2554/4044; B60W 2554/80

(57) ABSTRACT

A driving assistance device includes a recognizer configured to recognize surrounding conditions of a vehicle, an estimator configured to estimate a traveling direction and a speed of a mobile object, and a notifier configured to perform a notification regarding the mobile object on the basis of a result of recognition by the recognizer and a result of estimation by the estimator. When the mobile object is traveling in a direction considered to be the same as the traveling direction of the vehicle, the notifier performs a notification if a current position of the mobile object is within a predetermined range from the vehicle, and performs, when the mobile object is traveling in a direction considered to be opposite to the traveling direction of the vehicle, a notification if a predicted position of the mobile object after a predetermined time is within a predetermined range from the vehicle.

### TECHNICAL FIELD

The present invention relates to a driving assistance device, a driving assistance method, and a program.

### BACKGROUND ART

In recent years, efforts to provide access to a sustainable transportation system that takes even vulnerable traffic participants among traffic participants into consideration have been gaining momentum. To make this realized, people are focusing on research and development to further improve traffic safety and convenience through research and development of driving assistance technology. In relation to this, conventionally, there are known technologies that output an alert when a lateral distance between a vehicle position and a bicycle position falls below a predetermined threshold distance, and that display an image indicating an object detected by an object detector on a display device at a focal length according to a distance to the object (for example, refer to Patent Documents 1 and 2).

### CITATION LIST

### Patent Document

Patent Document 1: Japanese Unexamined Patent Application, First Publication No.2021-185486

Patent Document 2: Japanese Unexamined Patent Application, First Publication No.2015-141490

### SUMMARY OF INVENTION

### Technical Problem

However, in driving assistance technology, when an occupant of a vehicle is notified of a surrounding object, depending on a movement direction of the object, there are cases where presence of the object cannot be notified at an appropriate timing.

To solve the problem described above, one of objectives of the present application is to provide a driving assistance device, a driving assistance method, and a program that can notify the occupant of a vehicle of information on a surrounding object at a more appropriate timing. This will ultimately contribute to the development of a sustainable transportation system.

### Solution to Problem

The driving assistance device, driving assistance method, and program according to the present invention have adopted the following configuration.

(1): A driving assistance device according to one aspect of the present invention includes a recognizer configured to recognize surrounding conditions of a vehicle, an estimator configured to estimate a traveling direction and a speed of a mobile object on the basis of a position and an attribute of the mobile object present in a vicinity of the vehicle, recognized by the recognizer, and a notifier configured to perform a notification regarding the mobile object on the basis of a result of recognition by the recognizer and a result of estimation by the estimator, in which, when the mobile object is traveling in a direction considered to be the same as the traveling direction of the vehicle, the notifier performs a notification if a current position of the mobile object is within a predetermined range from the vehicle, and performs, when the mobile object is traveling in a direction considered to be opposite to the traveling direction of the vehicle, a notification if a predicted position of the mobile object after a predetermined time is within a predetermined range from the vehicle.

(2): In the aspect of (1) described above, the mobile object may include a bicycle.

(3): In the aspect of (1) described above, the mobile object may be a mobile object that moves in a traveling lane of the vehicle, or a shoulder or roadside strip in contact with the traveling lane.

(4): In the aspect of (1) described above, the notifier may perform the notification based on the predicted position and the position of the vehicle when the mobile object is present outside the traveling lane of the vehicle and the estimator estimates that the position of the mobile object after a predetermined time is present within the traveling lane.

(5): In the aspect of (1) described above, the notifier may perform the notification based on the current position of the mobile object and the position of the vehicle when the mobile object is present outside the traveling lane of the vehicle and a speed of the mobile object is equal to or greater than a predetermined speed.

(6): In the aspect of (4) or (5) described above, the outside of the traveling lane of the mobile object may be a lane adjacent to the traveling lane of the vehicle.

(7): A driving assistance method according to another aspect of the present invention includes, by a computer, recognizing surrounding conditions of a vehicle, estimating a traveling direction and a speed of a mobile object present in a vicinity of the vehicle on the basis of a position and an attribute of the mobile object, which are recognized, performing a notification regarding the mobile object on the basis of a result of the recognition and a result of the estimation, performing, when the mobile object is traveling in a direction that is considered to be the same as the traveling direction of the vehicle, a notification when if a current position of the mobile object is within a predetermined range from the vehicle, and performing, when the mobile object is traveling in a direction that is considered to be opposite to the traveling direction of the vehicle, a notification if a predicted position of the mobile object after a predetermined time is within a predetermined range from the vehicle.

(8): A program according to still another aspect of the present invention is a program causing a computer to execute recognizing surrounding conditions of a vehicle, estimating a traveling direction and a speed of a mobile object on the basis of a position and an attribute of the mobile object present in a vicinity of the vehicle, which are recognized, performing a notification regarding the mobile object on the basis of a result of the recognition and a result of the estimation, performing, when the mobile object is traveling in a direction that is considered to be the same as the traveling direction of the vehicle, a notification when if a current position of the mobile object is within a predetermined range from the vehicle, and performing, when the mobile object is traveling in a direction that is considered to be opposite to the traveling direction of the vehicle, a notification if a predicted position of the mobile object after a predetermined time is within a predetermined range from the vehicle.

### Advantageous Effects of Invention

According to the aspects (1) to (8) described above, information related to objects in the vicinity can be notified to an occupant of the vehicle at a more appropriate timing.

### BRIEF DESCRIPTION OF DRAWINGS

FIG. 1 A configuration diagram of a vehicle system 1 using a driving assistance device according to an embodiment.

FIG. 2 A diagram for describing notification processing in processing in a first situation.

FIG. 3 A diagram for describing notification processing in processing in a second situation.

FIG. 4 A diagram for describing notification processing in processing in a third situation.

FIG. 5 A diagram for describing a determination based on a speed VOB4 of an object OB4.

FIG. 6 A flowchart which shows an example of the notification processing in the first and second situations.

FIG. 7 A flowchart which shows an example of the notification processing in the third situation.

### DESCRIPTION OF EMBODIMENTS

Hereinafter, embodiments of a driving assistance device, a driving assistance method, and a program of the present invention will be described with reference to the drawings. In the following, a case in which a law of driving on a left side applies will be described, but if a law of driving on a right side applies, left and right can be read in reverse.

### Overall Configuration

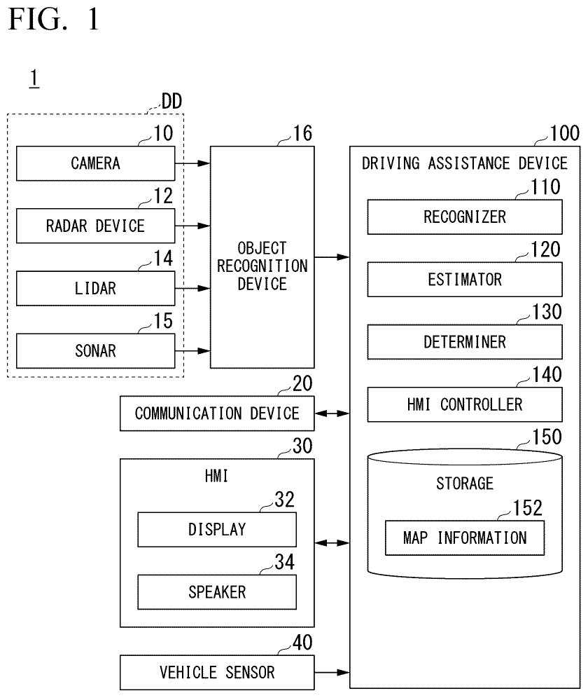

FIG. 1 is a configuration diagram of a vehicle system 1 that uses a driving assistance device according to an embodiment. A vehicle (hereinafter referred to as a vehicle M) in which the vehicle system 1 is mounted is, for example, a two-wheeled, three-wheeled, or four-wheeled vehicle, and its driving source is an internal combustion engine such as a diesel engine or a gasoline engine, an electric motor, or a combination of these. The electric motor operates using electric power generated by a generator connected to the internal combustion engine, or discharged electric power from a secondary battery or a fuel cell.

The vehicle system 1 includes, for example, a camera 10, a radar device 12, a light detection and ranging (LIDAR) 14, a sonar 15, an object recognition device 16, a communication device 20, a human machine interface (HMI) 30, a vehicle sensor 40, and a driving assistance device 100. These devices and equipment are connected to each other by multiple communication lines such as a controller area network (CAN) communication line, a serial communication line, a wireless communication network, and the like. Note that constituents shown in FIG. 1 are merely examples, and some of the constituents may be omitted, or other constituents may be added. The camera 10, the radar device 12, the LIDAR 14, and the sonar 15 are examples of a “detection device DD.” The detection device DD may include the object recognition device 16. The HMI 30 and the HMI controller 140 described below are examples of a “notifier.”

The camera 10 is a digital camera using a solid-state imaging element such as a charge coupled device (CCD) or a complementary metal oxide semiconductor (CMOS). The camera 10 is attached to any location of the vehicle M in which the vehicle system 1 is mounted. When an image of the front is captured, the camera 10 is attached to a top of the front windshield or a back of the room mirror. When an image of a rear of the vehicle M is captured, the camera 10 is attached to a top of the rear windshield. When an image of a right or left side of the vehicle M is captured, the camera 10 is attached to a right or left side of a vehicle body or the door mirror. The camera 10, for example, periodically and repeatedly captures images of surroundings of the vehicle M. The camera 10 may be a stereo camera.

The radar device 12 emits radio waves such as millimeter waves to the vicinity of the vehicle M, and detects radio waves (reflected waves) reflected by an object to detect at least a position (a distance and a direction) of an object. The radar device 12 is attached to any location on the vehicle M. The radar device 12 may detect the position and speed of the object using a frequency modulated continuous wave (FM-CW) method.

The LIDAR 14 emits light (or electromagnetic waves with a wavelength close to that of light) to the vicinity of the vehicle M and measures scattered light. The LIDAR 14 detects a distance to a subject on the basis of a time between emission and reception of the light. The emitted light is, for example, a pulsed laser light. The LIDAR 14 is attached to any location on the vehicle M. The LIDAR 14 detects the distance from the vehicle M to the subject by scanning horizontally and vertically with respect to the traveling direction of the vehicle M.

The sonar 15 emits ultrasonic waves to the vicinity of the vehicle M and detects reflection or scattering by an object that is present within a predetermined distance from the vehicle M, thereby detecting the distance, position, or the like of the object. The sonar 15 is installed, for example, on front and rear ends of the vehicle M, on a bumper, or the like.

The object recognition device 16 performs sensor fusion processing on a result of the detection from some or all of the detection devices DD (the camera 10, the radar device 12, the LIDAR 14, and the sonar 15) to recognize a position, a type, a speed, and the like of the object. The object recognition device 16 outputs a result of the recognition to the driving assistance device 100. The object recognition device 16 may output a result of the detection of the detection device DD to the driving assistance device 100 as it is. Note that a function of the object recognition device 16 may be incorporated into the driving assistance device 100, and the object recognition device 16 may be omitted from the vehicle system 1.

The communication device 20 communicates with, for example, other vehicles in the vicinity of the vehicle M, a terminal device of a driver using the vehicle M, or various server devices, using a network such as a cellular network, a Wi-Fi network, Bluetooth (registered trademark), dedicated short range communication (DSRC), a local area network (LAN), a wide area network (WAN), or the Internet.

The HMI 30 presents various types of information to an occupant of the vehicle and receives an input operation by the occupant. The HMI 30 includes, for example, a display 32 and a speaker 34. The display 32 may be, for example, a meter display in front of a driver's seat, a display device provided in a center of an instrument panel, or a head-up display (HUD). The speaker 34 may be, for example, a vocal sound output device provided in a vehicle compartment of the vehicle M. In addition to the display 32 and the speaker 34, the HMI 30 may include a buzzer, a touch panel, a switch, keys, a microphone, and the like.

The vehicle sensor 40 includes a vehicle speed sensor that detects a speed of the vehicle M, an acceleration sensor that detects the acceleration, a yaw rate sensor that detects the yaw rate (for example, the rotational angular speed around a vertical axis passing through a center of gravity of the vehicle M), and a direction sensor that detects a direction of the vehicle M. The vehicle sensor 40 may also be provided with a position sensor that detects a position of the vehicle M. The position sensor is, for example, a sensor that acquires position information (longitude and latitude information) from a global positioning system (GPS) device. The position sensor may also be a sensor that acquires position information using a global navigation satellite system (GNSS) receiver.

The driving assistance device 100 is a device that assists the driver in driving the vehicle M. The driving assistance device 100 includes, for example, a recognizer 110, an estimator 120, a determiner 130, an HMI controller 140, and a storage 150. The recognizer 110, the estimator 120, the determiner 130, and the HMI controller 140 are each realized by, for example, a hardware processor such as a central processing unit (CPU) executing a program (software). In addition, some or all of these components may be realized by hardware (including circuitry) such as a large scale integration (LSI), an application specific integrated circuit (ASIC), a field-programmable gate array (FPGA), or a graphics processing unit (GPU), or may be realized by software and hardware in cooperation. The program may be stored in advance in a storage device (a storage device having a non-transient storage medium) such as an HDD or flash memory of the driving assistance device 100, or may be stored in a removable storage medium such as a DVD or CD-ROM, and may be installed in the HDD or flash memory of the driving assistance device 100 by mounting the storage medium (non-transient storage medium) in a drive device.

The storage 150 may be realized by the various storage devices described above, or an electrically erasable programmable read only memory (EEPROM), a read only memory (ROM), or a random access memory (RAM). For example, the storage 150 stores information necessary for executing various types of control in the embodiment, programs, various types of information, and the like. The storage 150 may also include map information 152. The map information 152 is, for example, information that expresses a road shape by links indicating roads in a specified section and nodes connected by the links. The map information 152 may also include point of interest (POI) information according to the position information, and may also include information related to road shapes and road structures. The road shape includes, for example, a branch, a junction, a tunnel (an entrance, an exit), a curved road (an entrances, an exit), curvature, a radius of curvature, the number of lanes, a width, a gradient, and the like of a road or a road dividing line (hereinafter referred to as a “dividing line”). The information related to a road structure may include, for example, a type, a position, a direction with respect to an extension direction of a road, a size, a shape, a color, and the like of the road structure. In the type of a road structure, for example, the dividing line may be one type, and each of a lane marking, a curb, a median strip, and a wall installed in an extension direction of a road (including a fence, and the like) that belong to the dividing line may be a different type. The map information 152 may be updated at any time by the communication device 20 communicating with other devices.

The recognizer 110 recognizes surrounding conditions of the vehicle M on the basis of an information input from some or all of the detection device DD, or an information input via the object recognition device 16. For example, the recognizer 110 recognizes states, such as an attribute, a position, a size, a speed, an acceleration, and the like of an object present in the vicinity of the vehicle M (within a predetermined distance). The attribute of an object may be, for example, a type of a vehicle, a pedestrian, a utility pole, or the like, or may also be a type for identifying a vehicle such as a four-wheeled vehicle, a two-wheeled vehicle, a bicycle, or an electric kickboard.

The position of an object may be recognized, for example, as a position in a map coordinate system, or as a position in an absolute coordinate system (vehicle coordinate system) with a representative point of the vehicle M (a center of gravity, a center of drive shaft, or the like) as the origin. The position of an object may be represented by a representative point such as the center of gravity or a corner of the object, or a leading end in the traveling direction, or may be represented by a represented area. For example, when the object is a mobile object such as another vehicle, the “state” of the object may include the acceleration or jerk of the object, or the “behavior state” (for example, whether the object is changing lanes or is about to change lanes). In addition, the recognizer 110 may recognize that an object is a mobile object (a dynamic object) or a static object based on an amount of movement of the recognized object in a predetermined time.

The recognizer 110 also recognizes road conditions in the vicinity of the vehicle M. The road conditions include positions of dividing lines that divide a road, positions of road boundaries, and conditions of an area from the dividing lines to the road boundaries (for example, roadside strips, shoulders). The road boundaries are boundaries of an area in which the vehicle M can travel, and are, for example, edges of a road surface, or, if there is an object such as a wall or curb outside the dividing line as viewed from the vehicle M, positions of edges of the object on road sides. The recognizer 110 may also recognize a distance between the recognized object and the dividing line, a distance between the object and the road boundary, and the like. The recognizer 110 may also recognize a traveling lane of the vehicle M and adjacent lanes.

When an object that is present in the vicinity (for example, within a predetermined distance) of the vehicle M recognized by the recognizer 110 is a mobile object, the estimator 120 estimates a movement vector including a traveling direction and speed information of the object on the basis of a position and an attribute of the object.

For example, the estimator 120 estimates the traveling direction from the difference (difference) in the position (coordinates) of the object at a predetermined time. The estimator 120 also estimates a speed of the object by dividing the amount of change in the position of the object at a predetermined time by the predetermined time. In addition, the estimator 120 may estimate current and near future (after a predetermined time) positions, traveling direction, and moving speed of the object according to the attribute of the estimator 120.

In addition, when the object is a mobile object, the estimator 120 may estimate the traveling direction and the movement speed of the mobile object after a predetermined time has elapsed, on the basis of a shape of a road near the mobile object and obstacles in the vicinity (for example, utility poles and parked vehicles).

On the basis of a result of the recognition by the recognizer 110 and a result of the estimation by the estimator 120, the determiner 130 determines whether to perform a notification to notify the occupant of the vehicle M of an object that is present in the vicinity of the vehicle M. Details of the determination processing will be described below.

On the basis of a result of the recognition by the recognizer 110 and a result of the determination by the determiner 130, the HMI controller 140 causes the HMI 30 to output predetermined information to perform a notification or the like on the occupant of the vehicle M. The predetermined information includes, for example, information for notifying the occupant that an object is present in the vicinity. The predetermined information may include contents of the result of the estimation by the estimator 120 and the result of the determination by the determiner 130. The predetermined information may include information related to traveling of the vehicle M, such as information related to a state of the vehicle M and driving assistance information. The information related to the state of the vehicle M may include, for example, information such as the speed, engine speed, and shift position of the vehicle M. The driving assistance information may include, for example, information that assists the occupant in performing a steering or speed operation so that the vehicle M avoids contact with an obstacle. The predetermined information may also include information that is not related to traveling control of the vehicle M, such as a television program received by the communication device 20 or other content (for example, vocal sound, video). The predetermined information may also include, for example, information related to the current position and destination of the vehicle M, and a remaining amount of fuel.

For example, the HMI controller 140 may generate an image including the predetermined information described above and display the generated image on the display 32 of the HMI 30, or may generate a vocal sound indicating the predetermined information and output the generated vocal sound from the speaker 34 of the HMI 30.

### Recognizer 110, Estimator, Determiner, HMI Controller

Next, the notification processing by the recognizer 110, the estimator 120, the determiner 130, and the HMI controller 140 will be specifically described. In the following description, contents of the notification processing will be described for each of several situations. In addition, the following description will also describe part of the processing by the recognizer 110.

### <First Situation>

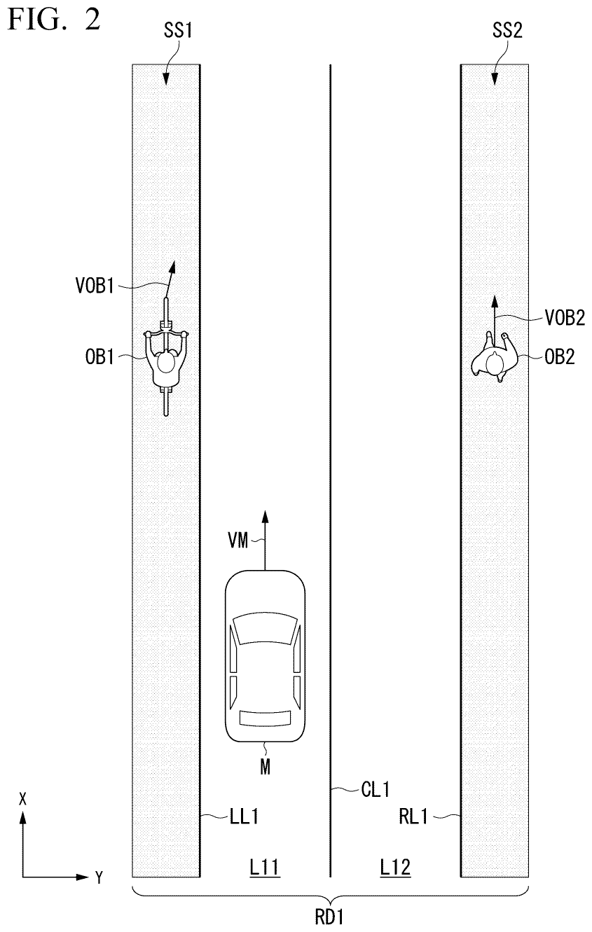

FIG. 2 is a diagram for describing the notification processing in processing in a first situation. In an example of FIG. 2, it is assumed that the vehicle M is traveling in a lane L11 of the road RD1 including the lane L11 and its oncoming lane L12 at a speed VM in an extension direction (an X-axis direction in FIG. 2). The lane L11 is divided by dividing lines LL1 and CL1, and the lane L12 is divided by dividing lines CL1 and RL1. In addition, as viewed from the vehicle M, a roadside strip SS1 is present outside the dividing line LL1, and a roadside strip SS2 is present outside the dividing line RL1 on the road RD1. The roadside strip SS1 is in contact with the lane L11, and the roadside strip SS2 is in contact with the lane L12. In addition, it is assumed that the roadside strip SS1 contains an object OB1 moving at a speed VOB1, and the roadside strip SS2 contains an object OB2 moving at a speed VOB2. In addition, when a sidewalk is present outside the roadside strips SS1 and SS2 on the road RD1 as viewed from the vehicle, the roadside strips SS1 and SS2 may be referred to as “shoulders SS1 and SS2.”

In the first situation, the recognizer 110 recognizes the positions, attributes, sizes, shapes, and the like of objects (objects OB1 and OB2) present in the vicinity of the vehicle M on the basis of a result of the detection from some or all of the detection device DD and a result of sensor fusion processing on the detection result. For example, the recognizer 110 performs known analysis processing (for example, edge extraction, feature extraction, pattern matching processing, character recognition processing, and the like) on surrounding images captured by the camera 10 (hereinafter, camera images), and recognizes that the object OB1 is a bicycle, that the object OB2 is a pedestrian (person), and their respective positions, sizes, shapes, and the like from a result of the image analysis. The recognizer 110 may also recognize the attribute, position, size, shape, and the like of an object contained in a camera image using a trained model that has been trained to use a camera image as an input and to use the type or position of an object contained in the image as an output.

The recognizer 110 also recognizes conditions of the road RD1 on which the vehicle M is traveling (for example, positions of the dividing lines LL1, CL1, and RL1, the traveling lane L11 of the vehicle M, an adjacent lane L12, and the like) on the basis of the result of the detection by some or all of the detection devices DD and the result of performing the sensor fusion processing on the detection result of the object recognition device 16. In addition, in an area recognized as the road RD1, the recognizer 110 recognizes an area outside the dividing line LL1 as viewed from vehicle M as the roadside strip SS1, and recognizes the area outside dividing line RL1 as viewed from the vehicle M as the roadside strip SS2.

In addition, the recognizer 110 may refer to the map information 152 stored in the storage 150 on the basis of position information of the vehicle M obtained from a position sensor of the vehicle sensor 40, and recognize, from the map information 152, the conditions of the road RD1 along which the vehicle M is traveling (the positions of the dividing lines LL1, CL1, and RL1, and the roadside strips SS1 and SS2), and the like. The recognizer 110 may also collate the recognition results of the detection device DD with the recognition results obtained from the map information 152 to recognize the road conditions in the vicinity of the vehicle M.

The recognizer 110 also repeatedly recognizes the surrounding conditions of the vehicle M at a predetermined cycle, recognizes the object as a mobile object (dynamic object) when an amount of movement of the recognized object in the predetermined cycle is equal to or greater than a predetermined amount, and recognizes the object as a static object when the amount of movement is less than the predetermined amount.

In the example of FIG. 2, the recognizer 110 recognizes that the objects OB1 and OB2 are present ahead (in the traveling direction) of the vehicle M traveling in the lane L11 at the speed VM, and further recognizes that the object OB1, whose attribute is a bicycle, is present in the roadside strip SS1, and the object OB2, whose attribute is a pedestrian, is present in the roadside strip SS2. Furthermore, recognizer 110 recognizes that the objects OB1 and OB2 are mobile objects.

The estimator 120 estimates a movement vector including the traveling direction and speed of each of the objects OB1 and OB2 recognized as mobile objects by the recognizer 110 on the basis of the attributes and positions of each of the objects OB1 and OB2. For example, the estimator 120 acquires the traveling direction and the movement amount from a difference in positions (coordinates) of the objects OB1 and OB2 in a predetermined cycle. The traveling direction may be a direction in a coordinate system based on the positions of the objects, may also be a direction (azimuth) in a map coordinate system, or may be a deviation angle with respect to an extension direction of a road. In addition, the estimator 120 calculates the speeds VOB1 and VOB2 of the objects OB1 and OB2 by dividing the movement amount by a time of the predetermined cycle.

Moreover, the estimator 120 estimates the traveling direction and speed information of the vehicle M. The traveling direction may be estimated based on, for example, a yaw rate or a direction sensor of the vehicle sensor 40, or may be estimated on the basis of a steering angle of a steering wheel mounted on the vehicle M. In addition, the estimator 120 may estimate the traveling direction and the movement amount based on the difference in position of the vehicle M in the predetermined cycle. Moreover, the speed of the vehicle M may also be acquired from a vehicle speed sensor included in the vehicle sensor 40, and the speed of the vehicle M may be calculated by dividing the movement amount by the time of the predetermined cycle.

In determination of whether to perform a notification to notify a user of an object present in the vicinity of the vehicle M, the determiner 130 first determines whether the objects OB1 and OB2 present in the vicinity of the vehicle M are traveling in substantially the same direction as the traveling direction of the vehicle M when the objects OB1 and OB2 are recognized as mobile objects. The “substantially the same direction” refers to a direction that can be regarded as the same direction as the traveling direction of the vehicle M, and is, for example, an angle including a predetermined allowable range (for example, about 45 degrees) on the left and right sides based on the traveling direction of the vehicle M (a direction indicated by an arrow indicated by the speed VM in FIG. 2). In the example of FIG. 2, the determiner 130 determines that the objects OB1 and OB2 are traveling in the same direction as the traveling direction of the vehicle M. Note that the determiner 130 performs the determination described above only for the lane L11 in which the vehicle M is traveling and an object present in the roadside strip SS1 in contact with the lane L11 (only the object OB1 in the example of FIG. 2), and may exclude an object present in the adjacent lane L12 or the roadside strip SS2 (for example, the object OB2) from the determination target described above. As a result, it is possible to perform determination processing on an object that is highly likely to come into contact with the vehicle M, thereby reducing a processing load. Furthermore, in addition to the conditions described above, the determiner 130 may also determine an object present in front (in the traveling direction) of the vehicle M as the determination subject, or may perform determination on an object approaching from behind.

For example, when it is determined that the object OB1 present in the roadside strip SS1 is traveling in substantially the same direction as the traveling direction of the vehicle M and when the object OB1 is present within a predetermined range from the vehicle M, the determiner 130 determines to perform a notification to notify the occupant of the vehicle M of an approach of the object OB1, and determines not to perform a notification when it is present outside the predetermined range. The predetermined range may be a fixed range or a variable range set on the basis of a time to collision (TTC). The time to collision TTC is a value derived by dividing a relative position (a relative distance) between the vehicle M and the object OB1a by a relative speed. For example, when the object OB1 is in a position where the time to contact TTC is less than a threshold value, the determiner 130 determines that the object OB1 is present within a predetermined range from the vehicle M.

When the determiner 130 determines to perform a notification to notify the occupant of the vehicle M of the approach of the object OB1, the HMI controller 140 may, for example, generate an image notifying a position and a direction of the object OB1 as viewed from the vehicle M and display it on the display 32, or generate a vocal sound such as an alarm to alert the occupant of an approach of the object OB1 and output it to the speaker 34. The HMI controller 140 may also display an image indicating that the object OB1 is traveling in substantially the same direction as the traveling direction of the vehicle M on the display 32.

### <Second Situation>

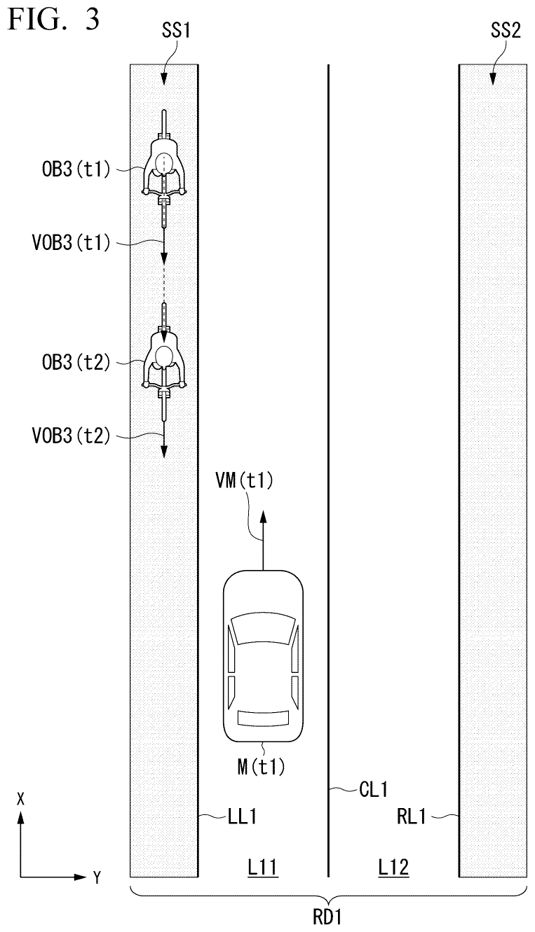

FIG. 3 is a diagram for describing notification processing in processing in the second situation. In the second situation, differences from the first situation will be mainly described, and a repeated description of an applicable part will be omitted. It is assumed that FIG. 3 shows conditions of the same road RD1 as in FIG. 2, and, instead of the objects OB1 and OB2, there is an object OB3 moving at a speed VOB3 on the roadside strip SS1. In the example of FIG. 3, it is assumed that a time t1 is earlier than a time t2. In addition, the positions of the object OB3 and the vehicle M at a time t* are represented as an object OB3(t*) and M(t*), and their respective speeds are represented as a speed VOB3(t*) and a speed VM(t*). The same applies to the positions and speeds of each object OB and the vehicle M at the time t* in other processing patterns described below.

In the second situation, the recognizer 110 recognizes a position and an attribute (bicycle) of the object OB3 present in front of the vehicle M, and recognizes that the object OB3 is a mobile object. The estimator 120 estimates a movement vector including the traveling direction and the speed VOB3 of the object OB3, which is a mobile object, on the basis of a result of the recognition by the recognizer 110.

In the second situation, the determiner 130 determines whether the object OB3, which is a mobile object, is traveling in a direction substantially opposite to the direction of the vehicle M. The substantially opposite direction is a direction that can be considered to be an opposite direction to the traveling direction of the vehicle M, and is, for example, a direction that includes a predetermined tolerance range (for example, about 45 degrees) to the left and right based on a direction that is exactly opposite to the traveling direction of the vehicle M. Furthermore, the substantially opposite direction may be a direction that is not substantially the same as the traveling direction of the vehicle M shown in the first situation. In the example of FIG. 3, the determiner 130 determines that the object OB3 is traveling in the direction substantially opposite to the vehicle M.

For example, when the determiner 130 determines that the object OB3 is traveling in the direction substantially opposite to the vehicle M at the time t1, the estimator 120 estimates a predicted position of the object OB3 after a predetermined time. The predetermined time may be, for example, a fixed time, or may be variably set on the basis of a road shape, the speed VOB3 and traveling direction of the object OB3 at the time t1, the speed VM and traveling direction of the vehicle M, and a time to contact TTC. Furthermore, the estimator 120 may also estimate the predicted speed and the predicted traveling direction after a predetermined time at the time t1. These predicted values (predicted position, predicted speed, and predicted traveling direction) may be estimated on the basis of actual measured values (position displacement, speed displacement, displacement in the traveling direction) of the object OB3 before the time t1, or may be estimated on the basis of past actual measured values of the same attribute (bicycle) as the object OB3. The actual measured values may be stored in the storage 150, for example. In the example of FIG. 3, an object OB(t2) indicates the predicted position of the object OB3 at the time t2, a predetermined time after the time t1, a speed VOB3(t2) indicates a speed of the object OB3 at the time t2, and a speed arrow indicates the traveling direction.

When the determiner 130 determines that the object OB3 is traveling in the direction substantially opposite to the vehicle M, it compares the predicted position of the object OB3 (object OB3(t2)) by the estimator 120 with the position of the vehicle (M(t1)). When the object OB3(t2) is present within a predetermined range from the vehicle M(t1), it determines to perform a notification to notify the occupant of the vehicle M of an approach of the object OB3, and when it is present outside the predetermined range, it determines not to perform a notification. The predetermined range may be set, for example, in the same manner as in the first situation.

When the determiner 130 determines to perform a notification, the HMI controller 140 generates an image or vocal sound including notification information to notify the occupant of the vehicle M of the approach of the object OB3, and outputs it to the HMI 30. In addition, the HMI controller 140 may display on the display 32 an image indicating that the object OB3 is traveling in the direction substantially opposite to the traveling direction of the vehicle M.

As shown in the second situation described above, when it is determined that the object OB3 and the vehicle M are traveling in substantially opposite directions, the determiner 130 determines whether a notification is required on the basis of the predicted future position of the object OB3 and the position of the vehicle M. As a result, it is possible to notify the occupant of an approach of the object at an earlier timing than when the object is traveling in substantially the same direction, and to alert the driver of the approach at a more appropriate timing. Therefore, even when the object OB3 is approaching the vehicle M (when an amount of displacement of a relative position in a predetermined time is larger than when the object is traveling in the same direction), the occupant can calmly perform a driving operation of the vehicle M to avoid contact.

### <Third Situation>

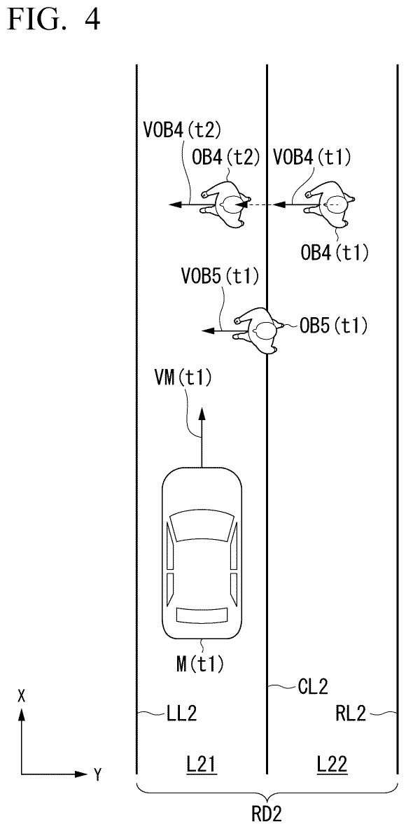

FIG. 4 is a diagram for describing notification processing in processing in a third situation. In FIG. 4, it is assumed that the vehicle M is traveling in a lane L21 of a road RD2 including the lane L21 and its oncoming lane L22 at the speed VM along the extension direction (an X-axis direction in FIG. 4). The lane L21 is divided by dividing lines LL2 and CL2, and the lane L22 is divided by dividing lines CL2 and RL2. It is assumed that an object OB4 is a pedestrian (mobile object) and is traveling from a lane L22 side adjacent to the lane L21 toward the lane L21 at a speed VOB4. In addition, it is assumed that an object OB5 is a pedestrian (mobile object) and is traveling in the lane L21 from a dividing line CL2 toward a dividing line LL2. In other words, the objects OB4 and OB5 are crossing pedestrians crossing the road RD2. The lane L22 is an example of “outside” with respect to the traveling lane L21 of the vehicle M.

In the third situation, the recognizer 110 recognizes the position and speed of the vehicle M, and the attributes (pedestrian), positions, and speeds of the objects OB4 and OB5 that are present in front of the vehicle M. The recognizer 110 may also recognize whether the objects OB4 and OB5 are objects that are present on the road RD2, or whether they are mobile objects.

When the estimator 120 recognizes that the objects OB4 and OB5 are mobile objects, it estimates a movement vector including the traveling direction and speed information of the objects OB4 and OB5. In addition, when the traveling directions of the objects OB4 and OB5 are substantially perpendicular to an extension direction of the lane L11 or the traveling direction of the vehicle M traveling on the lane L11, it may be determined that the objects OB4 and OB5 are crossing the road RD22. The substantially perpendicular direction is a direction that can be considered to be a lateral direction (a lane width direction) of the lane L11 or a lateral direction (a vehicle width direction) of the vehicle M, and is, for example, an angle including a predetermined allowable range (for example, about 45 degrees) on the left and right sides based on the lane width direction or vehicle width direction. In addition, the substantially perpendicular direction may be a direction other than substantially the same direction and the substantially opposite directions.

In addition, the estimator 120 estimates a predicted position of the object after a predetermined time when the position of the object is the lane L22 and a moving direction of the object is the traveling lane L21 of the vehicle M. At the time t1 in FIG. 4, the object OB4 is present in the lane L22 adjacent to the traveling lane L21, and is traveling in the lane L21, so that the estimator 120 estimates the predicted position (object OB4(t2)) of the object OB4 at the time t2 after a predetermined time. The estimator 120 may also estimate the speed VOB4(t2) and traveling direction of the object OB4 at the time t2.

When an object recognized by the recognizer 110 as a mobile object is positioned outside the traveling lane L21 of the vehicle M and the predicted position of the object after a predetermined time estimated by the estimator 120 is estimated to be within the traveling lane, the determiner 130 determines to perform a notification to notify the occupant of the vehicle M of the approach of the object based on the predicted position and the position of the vehicle M, and determines not to perform a notification when the object is present outside the predetermined range.

For example, at the time t1 in FIG. 4, the object OB4 (t1) is positioned in the lane L22 adjacent to the traveling lane L21 of the vehicle M, and the predicted position (the object OB4 (t2)) after a predetermined time at the time t2 estimated by the estimator 120 is present in the traveling lane L21. Therefore, when the predicted position of the object OB4 (the object OB4(t2)) is present within a predetermined range from the vehicle M(t1), the determiner 130 determines to perform a notification to notify the occupant of the vehicle M of the approach of the object OB4, and when it is present outside the predetermined range, determines not to perform a notification. The predetermined range may be set, for example, in the same manner as in the first situation. In addition, the determiner 130 determines not to perform a notification to notify the occupant of vehicle M of the approach of the object OB4 even when the position of the object OB4(t2) at the time t2 is not present within the traveling lane L21.

In addition, as shown in FIG. 4, when the object OB5 is present in the traveling lane L21 of the vehicle M, regardless of whether the object OB5 is a mobile object (a stationary object), when a position (OB5(t1)) of the object OB5 is present within a predetermined range from the vehicle M(t1), the determiner 130 determines to perform a notification to notify the occupant of the vehicle M of the approach of the object OB5, and when the position of the object is present outside the predetermined range, determines not to perform a notification.

When determiner 130 determines to perform a notification, the HMI controller 140 generates an image or vocal sound including notification information to notify the occupant of the vehicle M of the approach of the objects OB4 and OB5, and outputs the image or vocal sound to the HMI 30. Moreover, the HMI controller 140 may display on the display 32 an image indicating that the objects OB4 and OB5 are crossing the traveling lane of the vehicle M.

Note that the determiner 130 may determine whether to estimate the predicted position after a predetermined time on the basis of the speed VOB4 of the object OB4 when, for example, at the time t1, the object OB4 is recognized as a mobile object and is present outside (lane L22) the traveling lane L11 of the vehicle M.

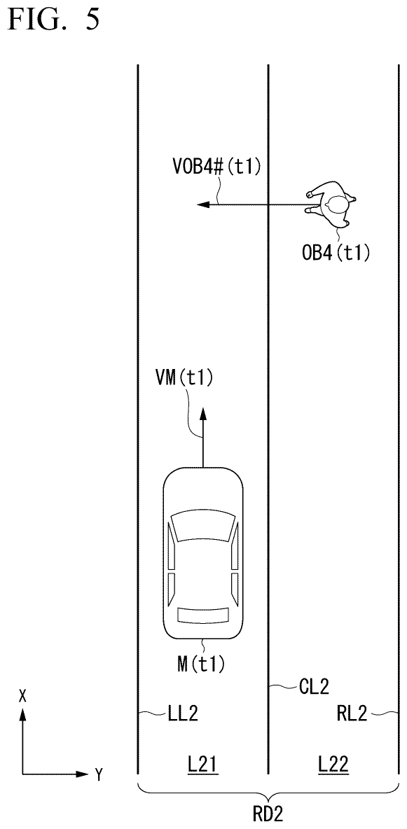

FIG. 5 is a diagram for describing a determination based on the speed VOB4 of the object OB4. An example in FIG. 5 shows an example in which the object OB4 is traveling toward the traveling lane L21 at a speed VOB4#. In a situation in FIG. 5, the determiner 130 determines whether the speed VOB4#of the object OB4 at the time tl is equal to or greater than a predetermined speed, and when it is equal to or greater than the predetermined speed, the determiner 130 determines to perform a notification to notify the occupant of vehicle M of the approach of the object OB4 when a current position (OB4(t1)) of the object OB4 is present within a predetermined range from the current position of the vehicle M(t1) without estimating the predicted position after a predetermined time, and determines not to perform a notification when the current position is present outside the predetermined range. As a result, it is possible to perform a quicker determination by omitting processing of estimating the predicted position when the object is traveling fast.

In the third situation, the lane L22 adjacent to the traveling lane L21 of the vehicle M is used as an example of “outside.” However, when there is a walking area such as a roadside strip outside the dividing line LL2 of the traveling lane L21 as viewed from the vehicle M, this walking area may also be an example of “outside.” In addition, when the vehicle M is traveling in the lane L22 on the road RD2, the lane L21 adjacent to the lane L22 is an example of “outside.”

The processing in the first to third situations described above may be combined with part or all of processing in the other situations. For example, in the first and second situations, when it is not determined that an object present in the vicinity of the vehicle M is moving in substantially the same direction as or in the substantially opposite direction to the vehicle M, the processing in the third situation may be executed. Moreover, for example, in a case of a situation that does not correspond to the first to third situations (for example, when the object is a stationary object), the HMI controller 140 compares current positions of the vehicle M and the object, and when the object is positioned within a predetermined range, performs a notification to notify the occupant of the approach of the object.

### Processing Flow

Hereinafter, a flow of a series of processing by the driving assistance device 100 of the embodiment will be described using a flowchart. In the following description, the notification processing in the first and second situations and the notification processing in the third situation among pieces of processing executed by the driving assistance device 100 will be mainly described separately. In addition, processing of this flowchart, for example, may be repeatedly executed at a predetermined timing or period.

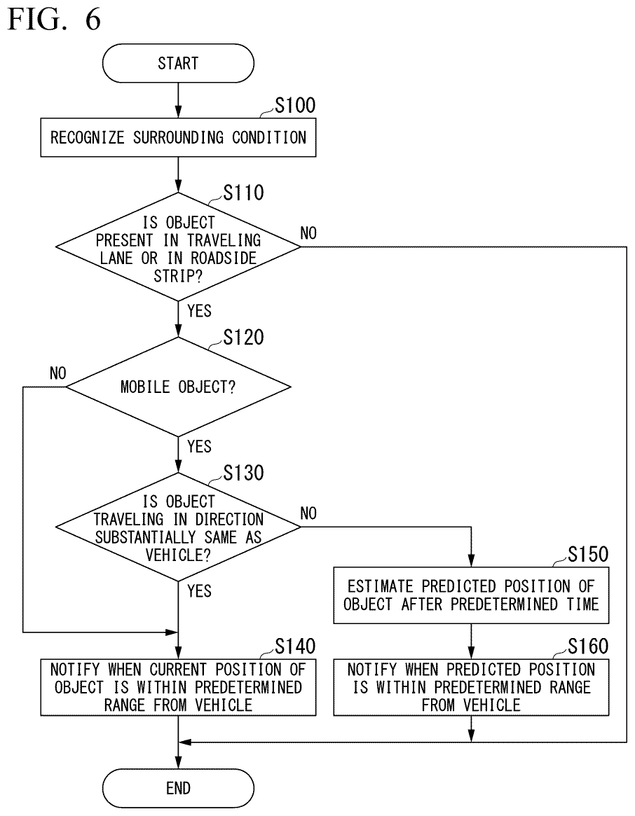

FIG. 6 is a flowchart which shows an example of the notification processing in the first and second situations. In an example of FIG. 6, the recognizer 110 recognizes the surrounding conditions of the vehicle M (step S100). Next, the determiner 130 determines whether an object is present in the traveling lane of the vehicle M or in a roadside strip (which may be rephrased as a shoulder) in contact with the traveling lane (step S110). When it is determined that an object is present, the determiner 130 determines whether the object is a mobile object (step S120). When it is determined that the object is a mobile object, the determiner 130 determines whether the object is traveling in a direction substantially the same as the traveling direction of the vehicle M (step S130).

When it is determined that the object is traveling in substantially the same direction as the traveling direction of the vehicle M, the HMI controller 140 generates an image, a vocal sound, or the like related to an object for the occupant of the vehicle M if a current position of the object is within a predetermined range from the vehicle M, and outputs it to the HMI 30 to notify the driver (step S140). In addition, when it is determined in processing of step S120 that the object is not a mobile object (is a stationary object), the HMI controller 140 executes processing of step S140. Note that the predetermined range in this case may be a shorter distance than when the object is determined to be a mobile object.

When it is determined in processing of step S130 that the object is not traveling in substantially the same direction as the traveling direction of the vehicle M, it is assumed that, in the example of FIG. 5, the object is considered to be traveling in the substantially opposite direction to the traveling direction of the vehicle M. In this case, the estimator 120 estimates the predicted position of the object after a predetermined time (step S150). When the predicted position of the object is within a predetermined range from the vehicle M, the HMI controller 140 generates an image or vocal sound related to the object for the occupant of the vehicle M, and outputs it to the HMI 30 to notify the driver (step S160). As a result, processing of this flowchart will end. In addition, when it is determined in processing of step S110 that the object is not present, the processing of this flowchart will end.

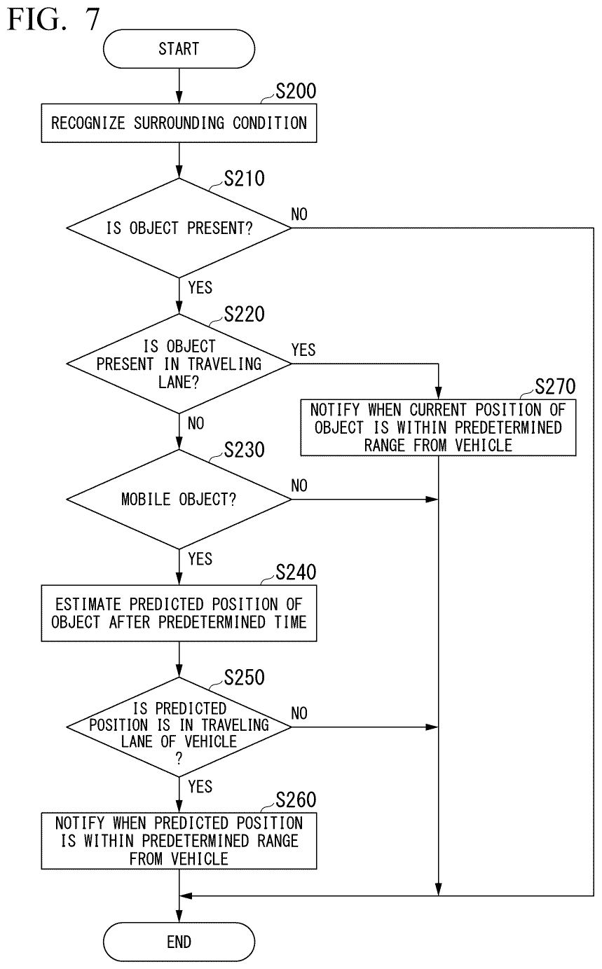

FIG. 7 is a flowchart which shows an example of notification processing in the third situation. In the example of FIG. 7, the recognizer 110 recognizes the surrounding conditions of the vehicle M (step S200). Next, the determiner 130 determines whether an object is present in the vicinity of the vehicle M (step S210). When it is determined that an object is present in the vicinity of the vehicle M, the determiner 130 determines whether the object is present in the traveling lane of the vehicle M (step S220). When it is determined that the object is not present in the traveling lane of the vehicle M, the determiner 130 determines whether the object is a mobile object (step S230). When it is determined that the object is a mobile object, the estimator 120 estimates a predicted position of the object after a predetermined time (step S240).

Next, the determiner 130 determines whether the predicted position of the object estimated by the estimator 120 is within the traveling lane of the vehicle M (step S250). Next, when the HMI controller 140 determines that the predicted position is within a predetermined range from the vehicle M, it generates an image, a vocal sound, or the like related to the object for the occupant of the vehicle M, and outputs it to the HMI 30 to notify the driver (step S260).

Moreover, when it is determined in processing of step S220 that the object is present in the traveling lane of the vehicle M, the HMI controller 140 generates an image, a vocal sound, or the like related to the object for the occupant of the vehicle M, and outputs it to the HMI 30 to notify the driver (step S270) when a current position of the object is within a predetermined range from the vehicle M. As a result, processing of this flowchart will end. In addition, when it is determined in processing of step S210 that the object is not present, when it is determined in processing of step S230 that the object is not a mobile object, or when it is determined in processing of step S250 that the predicted position is not within the traveling lane of the vehicle, this flowchart will end.

### Modified Example

For example, the vehicle system 1 of the embodiment may be equipped with a driving control device (not shown) that automatically controls one or both of steering and a speed of the vehicle M to perform driving control of the vehicle M. In this case, instead of (or in addition to) performing a notification indicating an approach of an object to the occupant of the vehicle M, the driving assistance device 100 may perform driving control such as the steering and speed (sudden braking) so that the vehicle M does not approach the object on the basis of a result of the determination described above.

Moreover, in the embodiment, when there are a plurality of objects ahead of the vehicle M, processing of determining whether to perform the notification described above may be performed for each object, or a priority may be assigned to the objects, and the processing described above may be performed in order of priority, or for objects with a priority equal to or greater than a threshold value. In this case, the priority may be higher as the object is closer to the vehicle M, may be higher as the object is larger, or may also be higher as the object is traveling faster. Moreover, the priority may be higher for dynamic objects than for static objects, and may be set according to the attribute of the object.

According to the embodiment described above, the driving assistance device 100 includes a recognizer 110 that recognizes the surrounding conditions of the vehicle M, an estimator 120 that estimates a traveling direction and a speed of a mobile object on the basis of a position and an attribute of the mobile object that is present in the vicinity of the vehicle M recognized by the recognizer 110, and a notifier (HMI controller 140, HMI 30) that performs a notification regarding the mobile object on the basis of a result of recognition by the recognizer 110 and a result of estimation by the estimator 120. When the mobile object is traveling in a direction that is considered to be the same direction as the traveling direction of the vehicle M, the notifier performs a notification when a current position of the mobile object is within a predetermined range from the vehicle M, and when the mobile object is traveling in a direction that is considered to be an opposite direction to the traveling direction of the vehicle M, the notifier performs a notification when a predicted position of the mobile object after a predetermined time is within a predetermined range from the vehicle M. By doing so, it is possible to notify the occupant of the vehicle of information on surrounding objects at a more appropriate timing.

For example, mobile objects such as bicycles traveling on roadside strips on a side of a road not only travel in the same direction as the vehicle M, but many also travel in the opposite direction. When it is determined whether to perform a notification regarding especially mobile objects to such mobile objects based on the current positions of the vehicle M and the mobile objects, there is a possibility that a timing of notification regarding especially mobile objects traveling in the opposite direction may be delayed. Therefore, in the embodiment, by distinguishing between cases based on traveling directions of the mobile objects, it is possible to perform a notification regarding the mobile objects to the occupant of the vehicle M at a more appropriate timing.

In addition, when there is a mobile object crossing the traveling lane of the vehicle M, the timing of notification may be delayed if it is determined whether to perform a notification regarding the mobile object based on the current positions of the vehicle M and the mobile object regardless of the position or speed of the mobile object. Therefore, in the embodiment, by determining whether to perform a notification regarding the current position of the vehicle M by switching between using the current position of the mobile object and using a predicted position of the mobile object after a predetermined time depending on the position and speed of the mobile object, it is possible to perform a notification regarding the mobile object to the occupant of the vehicle M at a more appropriate timing.

The embodiments described above can be expressed as follow.

A driving assistance device includes a storage medium that stores computer-readable instructions, and a processor connected to the storage medium, wherein the processor executes the computer-readable instructions to recognize surrounding conditions of a vehicle, estimate a traveling direction and a speed of a mobile object present in a vicinity of the vehicle on the basis of a position and an attribute of the mobile object, which are recognized by the recognizer, and perform a notification regarding the mobile object on the basis of a result of recognition and a result of estimation, when the mobile object is traveling in a direction considered to be the same as the traveling direction of the vehicle, the notifier performs a notification if a current position of the mobile object is within a predetermined range from the vehicle, and performs, when the mobile object is traveling in a direction considered to be opposite to the traveling direction of the vehicle, a notification if a predicted position of the mobile object after a predetermined time is within a predetermined range from the vehicle.

The above describes a form for carrying out the present invention using an embodiment, but the present invention is not limited to such an embodiment, and various modifications and substitutions can be made within a range not departing from the gist of the present invention.

### REFERENCE SIGNS LIST

1 Vehicle system
10 Camera
12 Radar device
14 LIDAR
15 Sonar
16 Object recognition device
20 Communication device
30 HMI
32 Display
34 Speaker
40 Vehicle sensor
100 Driving assistance device
110 Recognizer
120 Estimator
130 Determiner
140 HMI controller
150 Storage
M Vehicle

What is claim is:

1. (canceled)

9. A driving assistance device comprising:
a recognizer configured to recognize surrounding conditions of a vehicle;
an estimator configured to estimate a traveling direction and a speed of a mobile object on the basis of a position and an attribute of the mobile object present in a vicinity of the vehicle, recognized by the recognizer; and
a notifier configured to perform a notification regarding the mobile object on the basis of a result of recognition by the recognizer and a result of estimation by the estimator,
wherein, when the mobile object is traveling in a direction considered to be the same as the traveling direction of the vehicle, the notifier performs a notification if a current position of the mobile object is within a predetermined range from the vehicle, and
performs, when the mobile object is traveling in a direction considered to be opposite to the traveling direction of the vehicle, a notification if a predicted position of the mobile object after a predetermined time is within a predetermined range from the vehicle.

10. The driving assistance device according to claim 9,
wherein the mobile object includes a bicycle.

11. The driving assistance device according to claim 9,
wherein the mobile object is a mobile object that moves in a traveling lane of the vehicle, or a shoulder or roadside strip in contact with the traveling lane.

12. The driving assistance device according to claim 9,
wherein the notifier performs the notification based on the predicted position and the position of the vehicle when the mobile object is present outside the traveling lane of the vehicle and the estimator estimates that the position of the mobile object after a predetermined time is present within the traveling lane.

13. The driving assistance device according to claim 9,
wherein the notifier performs the notification based on the current position of the mobile object and the position of the vehicle when the mobile object is present outside the traveling lane of the vehicle and a speed of the mobile object is equal to or greater than a predetermined speed.

14. The driving assistance device according to claim 12,
wherein the outside of the traveling lane of the vehicle is a lane adjacent to the traveling lane of the vehicle.

15. The driving assistance device according to claim 13,
wherein the outside of the traveling lane of the vehicle is a lane adjacent to the traveling lane of the vehicle.

16. A driving assistance method comprising:
by a computer,
recognizing surrounding conditions of a vehicle;
estimating a traveling direction and a speed of a mobile object present in a vicinity of the vehicle on the basis of a position and an attribute of the mobile object, which are recognized;
performing a notification regarding the mobile object on the basis of a result of the recognition and a result of the estimation;
performing, when the mobile object is traveling in a direction that is considered to be the same as the traveling direction of the vehicle, a notification if a current position of the mobile object is within a predetermined range from the vehicle; and
performing, when the mobile object is traveling in a direction that is considered to be opposite to the traveling direction of the vehicle, a notification if a predicted position of the mobile object after a predetermined time is within a predetermined range from the vehicle.

17. A non-transitory computer-readable storage medium that stores a program to be executed by a computer to perform at least:
recognizing surrounding conditions of a vehicle;
estimating a traveling direction and a speed of a mobile object on the basis of a position and an attribute of the mobile object present in a vicinity of the vehicle, which are recognized;
performing a notification regarding the mobile object on the basis of a result of the recognition and a result of the estimation;
performing, when the mobile object is traveling in a direction that is considered to be the same as the traveling direction of the vehicle, a notification if a current position of the mobile object is within a predetermined range from the vehicle; and
performing, when the mobile object is traveling in a direction that is considered to be opposite to the traveling direction of the vehicle, a notification if a predicted position of the mobile object after a predetermined time is within a predetermined range from the vehicle.
